(19) United States
(12) Patent Application Publication
(10) Pub. No.: US 2010/0278096 A1
(43) Pub. Date: Nov. 4, 2010

(54) RELAY AND RELATED METHOD

(75) Inventors: Haifeng Wang, Shanghai (CN); Shengyao Jin, Shanghai (CN); Ling Tang, Shanghai (CN); Bin Zhou, Shanghai (CN); Honglin Hu, Shanghai (CN); Jing Xu, Shanghai (CN)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/738,827

(22) PCT Filed: Oct. 19, 2007
(86) PCT No.: PCT/EP07/61226

§ 371 Date: Jun. 2, 2010

(51) Int. Cl. H04B 7/14

(52) U.S. Cl. 370/315

(57) ABSTRACT

A relay method comprising receiving data from a first node and a second node; estimating the symbols in the data received from said first node and said second node; transmitting the estimated data from the first node to the second node and the estimated data from the second node to the first node.

### FIELD OF THE INVENTION

The present invention relates to a relay and a method of relaying signals.

### BACKGROUND OF THE INVENTION

Network using relays for forwarding information are well known. In wireless networks such as cellular wireless networks, it is known to provide relay units for signals for transmitting between a base station and user equipment such as a mobile terminal or the like. For example, the radio signal transmitted by a base station may be received by the relay and re-transmitted by that relay to the user equipment. Likewise, a signal from user equipment is transmitted and received by the relay and is then re-transmitted by the relay unit to the base transceiver station.

A relay can be used for a number of different reasons. In one scenario, the use of a relay station means that the effective area of coverage of a base station can be increased. In other scenarios, the use of a relay station means that the power with which a base station needs to transmit can be reduced.

In some scenarios, bidirectional traffic may exist between two nodes (such as a base station and a user equipment) which communicate via a relay node.

In one known scenario, in a first time slot, the first node transmits to the relay. In a second time slot, the second node transmits to the relay. In a third time slot, the relay transmits the signal from the first node to the second node. In the fourth slot, the relay transmits the signal from the second node to the first node. This is a basic example of bidirectional relaying.

More complex forms of bidirectional relaying have been proposed, one example of which is the decode-and-forward (DF scheme). The relay decodes data received from the first node and the second node respectively. The composite data is encoded with a bitwise XOR (Exclusive OR) operation, amplified and transmitted to the first and second nodes at the same time. However, this scheme does have the disadvantage that it cannot be used with complex symbols in that the scheme operates at the bit level.

Another known scheme is the so-called amplify-and-forward (AF scheme). This is discussed in Petar Popovski, Hiroyuki Yomo, “Bi-directional Amplification of Throughput in a Wireless Multi-Hop Network”, Vehicular Technology Conference, IEEE 63rd, vol. 2, pp. 588-593, 2006. In this scenario, the first node requires knowledge of the channel state information (CSI) between the relay and the second node in order to detect the signal from the second node, and vice-versa. However, in order to obtain the necessary CSI results in a relatively large signalling overhead.

Reference is made to A Sendonaris, “Advanced Techniques for Next-Generation Wireless Systems”, Ph.D. Thesis, Rice University, August 1999. This discusses various aspects of relays.

By way of background only, reference is made to K. Witrisal, Y. H. Kim, R. Prasad, and L. P. Lighthart, “Pre-equalization for the Up-link of TDD OFDM Systems”, Personal, Indoor and Mobile Radio Communications, 12th IEEE International Symposium, vol. 2, pp. 93-98, 2001. This discloses pre-equalization for the uplink of a TDD OFDM (time division duplex orthogonal frequency division multiplexing) system. This is not in the context of a relay scenario.

It is an aim of some embodiments of the present invention to address or mitigate one or more of the problems discussed.

### SUMMARY OF THE INVENTION

According to one aspect of the present invention, there is provided a relay method comprising receiving data from a first node and a second node; estimating the symbols in the data received from said first node and said second node; transmitting the estimated data from the first node to the second node and the estimated data from the second node to the first node.

According to another aspect of the present invention, there is provided a relay comprising a receiver configured to receive data from a first node and a second node; an estimator configured to estimate the symbols in the data received from said first node and said second node; and a transmitter configured to transmit the combined data from the first node to the second node and the estimated data from the second node to the first node.

According to further aspect of the present invention, there is provided a relay method comprising pre-equalising a first signal to be transmitted at a first node; transmitting from said first node said pre-equalised first signal to a relay; pre-equalising a second signal to be transmitted at a second node; transmitting from said second node said pre-equalised second signal to said relay; receiving said signals transmitted by said first and second nodes and said relay; and transmitting said received signals to said first and second nodes from said relay.

According to another aspect of the present invention, there is provided a relay system comprising a first node, a second node and a relay therebetween, said first node being configured to pre-equalise a first signal and transmit from said first node said pre-equalised first signal to said relay, said second node being configured to pre-equalise a second signal and to transmit from said second node said pre-equalised second signal to said relay, and said relay being configured to receive said signals transmitted by said first and second nodes and to transmit said received signals to said first and second nodes.

According to a further aspect of the present invention, there is provided a node configured to pre-equalise a first signal and transmit said pre-equalised signal to a relay, to receive a signal from a relay and to process said received signal to remove a component based on said first signal therefrom to estimate a signal transmitted from a second node to said node via said relay.

### BRIEF DESCRIPTION OF DRAWINGS

For a better understanding of the present invention and as to how the same may be carried out, reference will now be made by way of example only to the accompanying drawings in which:

FIG. 1a illustrates conventional bidirectional relaying;

FIG. 1b illustrates conventional decode-and-forward bidirectional amplification of the throughput (DF BAT);

FIG. 1c shows conventional amplify-and-forward BAT relaying;

FIG. 1d shows a decode-and-forward scheme embodying the present invention;

FIG. 1e shows an amplify-and-forward scheme embodying the present invention;

FIG. 2 shows a flow diagram of a method in accordance with the detect-and-forward scheme embodying the present invention;

FIG. 3 is a flow diagram of the amplify-and-forward method embodying the present invention;

FIG. 4 schematically shows a first relay node embodying the present invention;

FIG. 5 schematically shows a second relay node embodying the present invention; and

FIG. 6 shows one example of a communication network within which embodiments of the present invention may be implemented.

### DETAILED DESCRIPTION OF PREFERRED EMBODIMENTS OF THE INVENTION

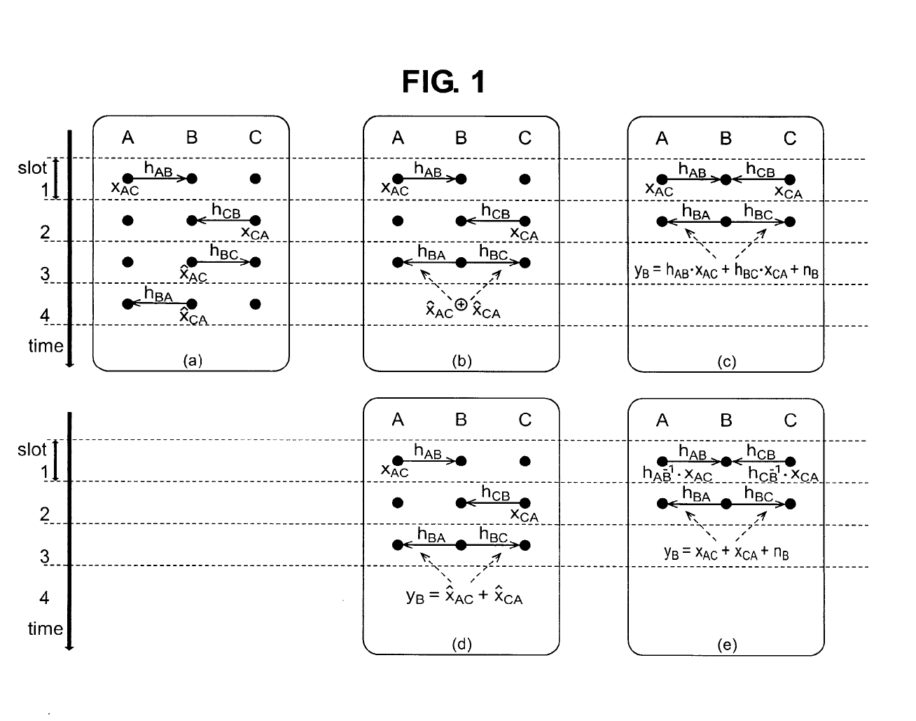

Reference will now be made to FIGS. 1a to e. Whilst FIGS. 1a to c show conventional bidirectional relaying scenarios, they will be discussed in more detail in order to facilitate an understanding of the embodiments of the present invention.

Reference will now be made generally to FIGS. 1a to e. In FIGS. 1a to 1e, there is an initial transmitter of signals and also a recipient. Node C is the recipient of the signal transmitted by Node A and also a transmitter of signals to Node A. Nodes A and C communicate via Node B which is a relay node. This notation of Nodes A, B and C is used in each of the FIGS. 1a to 1e. The representations of FIGS. 1a to e show the signal flow in four consecutive time slots in the case of FIG. 1a, three consecutive time slots in relation to FIGS. 1b and 1d, and two consecutive time slots in relation to FIGS. 1e and 1e.

Referring first to FIG. 1a, this shows that the first node, Node A wants to transmit a packet X_{AC} to Node C. Accordingly, in slot 1, the first node, Node A transmits the packet X_{AC} to the relay, that is Node B. h_{AB} represents the channel fading coefficient between the first node, Node A, and the relay, Node B. This is the channel impulse response.

In the next time slot, time slot 2, the second node, Node C transmits a packet X_{CA} to the relay node, Node B. This packet is intended for the first node, Node A. h_{CB} represents the channel fading coefficient between the second node, Node C and the relay, Node B. In the third time slot, the relay node, Node B transmits the packet which it has received from the first node, Node A to the second node, Node C. The packet which is transmitted by the relay node is \hat{X}_{AC}. The relay node, node B thus transmits the estimates of the packet X_{AC} transmitted by the first node. Likewise, in the fourth slot, the relay node transmits the packet which is the estimates of the packet X_{CA} received from the second node, to the first node.

Reference is now made to FIG. 1b which shows a decode-and-forward scheme. In this scenario, the signalling which takes place in the first two time slots is the same as in the arrangement shown in FIG. 1a. However, in the third time slot the relay node, Node B decodes the data which has been received from the first and second nodes respectively. The relay, Node B, applies a canonical network coding operation and broadcasts the packet x_{B}=\hat{x}_{AC}⊕\hat{x}_{CA} where ⊕ denotes the bitwise XOR operation. In other words the packets received by the relay nodes from the first and second nodes are combined in a bitwise operation. Since the first node Node A already has knowledge of x_{AC}, the first node extracts the required packet \hat{X}_{CA} through \hat{x}_{CA}=x_{B}⊕x_{AC}. Similarly, the second node, Node C extracts the require packet \hat{x}_{AC}=x_{B}⊕x_{CA}. The relaying method of FIG. 1B requires only 3 time slots to transfer the packets x_{AC} and x_{CA}. However, this method has to be performed at the bit level.

Reference is now made to FIG. 1c which shows an amplify-and-forward scheme which has previously been proposed. This proposal is able to operate at the symbol level. In the first time slot, both the first node, Node A and the second node, Node C transmit at the same time to the relay node, Node B. The first node, Node A, transmits the packet X_{AC} whilst the second node, Node C, transmits the packet X_{CA}. Assuming that x_{AC} and x_{CA} are the complex baseband at the symbols level, and that the expected values are E{x_{AC}}=E{x_{CA}}=0 and E{|x_{AC}|²}=E{|x_{CA}|²}=1, the received symbol y_{B} at the relay node, Node B can be written as:

y_{B}=h_{AB}x_{AC}+h_{CB}x_{CA}+n_{B} (2.1)

The value n_{B} is a complex value additive Gaussian white noise at the receiver of the relay, Node B with variance σ_{B}². During the second time slot, the relay, Node B amplifies y_{B} with a normalization factor β and broadcasts the resulting signal to both first node and the second node. The signal y_{A} received by the first node, Node A can be written:

$$\begin{matrix}{y}_{A} = β {h}_{BA} {y}_{B} + {n}_{A} \\ = β {h}_{BA} {h}_{AB} {x}_{A C} + β {h}_{BA} {h}_{CB} {x}_{CA} + \\ β {h}_{BA} {n}_{B} + {n}_{A}\end{matrix} \qquad ( 2.2 )$$

n_{A} is a complex value additive Gaussian white noise at the receiver of the first node, Node A.

The average transmitted signal energy over one symbol period at the relay is the same as at the first node such that

$$β = \sqrt{\frac{1}{{\vert {h}_{AB} \vert}^{2} + {\vert {h}_{CB} \vert}^{2} + {σ}_{B}^{2}}} \qquad ( 2.3 )$$

Assuming the first node, Node A has the CSI knowledge of h_{AB}, h_{BA}, h_{CB} and β, the transmitted signal by the first node can be subtracted from received signal as

$$\begin{matrix}{r}_{A} = β {h}_{BA} {h}_{AB} {x}_{A C} + β {h}_{BA} {h}_{CB} {x}_{CA} + \\ β {h}_{BA} {n}_{B} + {n}_{A} - β {h}_{BA} {h}_{AB} {x}_{A C} \\ = β {h}_{BA} {h}_{CB} {x}_{CA} + β {h}_{BA} {n}_{B} + {n}_{A}\end{matrix} \qquad ( 2.4 )$$

Then x_{CA} can be estimated as

\hat{x}_{CA}=β⁻¹h_{BA}⁻¹h_{CB}⁻¹r_{A} (2.5)

βh_{ba}n_{B}+n_{A} is included in r_{A}, and the term is the noise that can not be cancelled, thus this gives the estimated data with error due to this term

Similarly, x_{AC} can be estimated as

r_{C}=βh_{BC}h_{AB}x_{AC}+βh_{BC}n_{B}+n_{C} (2.6)

\hat{x}_{AC}=β⁻¹h_{BC}⁻¹h_{AB}⁻¹r_{C} (2.7)

n_{c} is a complex value additive Gaussian white noise at the receiver of the second node, Node B.

It can be noticed that the requirements for knowledge of the CSI between the relay and source nodes, and CSI between the relay and destination nodes may require a large signalling overhead.

Reference is now made to FIG. 1d which shows a detect-and-forward scheme embodying the present invention.

As shown in FIG. 1d, during the first time slot, the received symbol at the relay from the first node is:

y_{B1}=h_{AB}x_{AC}+n_{B} (3.1)

The received signal is then equalized in the relay and the transmitted signal from the first node, node A can be estimated by hard-decisions at the symbol level as

$$\begin{matrix}{\hat{x}}_{A C} = {h}_{AB}^{- 1} {y}_{B 1} \\ = {h}_{AB}^{- 1} ( {h}_{AB} {x}_{A C} + {n}_{B} ) \\ = {x}_{A C} + {h}_{AB}^{- 1} {n}_{B}\end{matrix} \qquad ( 3.2 )$$

Similarly during the second time slot, the received signal y_{B2} from the second node, Node C, is equalized. This is channel equalisation. The transmitted signal from node C can be estimated by hard-decisions at the symbol level as

$$\begin{matrix}{\hat{x}}_{CA} = {h}_{CB}^{- 1} {y}_{B 2} \\ = {h}_{CB}^{- 1} ( {h}_{CB} {x}_{CA} + {n}_{B} ) \\ = {x}_{CA} + {h}_{CB}^{- 1} {n}_{B}\end{matrix} \qquad ( 3.3 )$$

The hard-decision symbols from both the first and second nodes are summed as

y_{B}=\hat{x}_{AC}÷\hat{x}_{CA} (3.4)

During the third time slot, the relay amplifies y_{B} with a normalization factor β and broadcasts it to both the first node A and second node C. The received signal at the first node A can be written as:

$$\begin{matrix}{y}_{A} = β {h}_{BA} {y}_{B} + {n}_{A} \\ = β {h}_{BA} ( {\hat{x}}_{A C} + {\hat{x}}_{CA} ) + {n}_{A}\end{matrix} \qquad ( 3.5 )$$

where

$$\begin{matrix}β = \sqrt{\frac{1}{E \{ {\vert {\hat{x}}_{A C} \vert}^{2} \} + E \{ {\vert {\hat{x}}_{CA} \vert}^{2} \}}} \\ = \sqrt{\frac{1}{2}}\end{matrix} \qquad ( 3.6 )$$

With the knowledge of h_{BA}, x_{AC} and β, x_{CA} can be estimated as:

\tilde{x}_{CA}=β⁻¹h_{BA}⁻¹r_{A} (3.7)

where

$$\begin{matrix}{r}_{A} = {y}_{A} - β {h}_{BA} {x}_{A C} \\ = β {h}_{BA} {\hat{x}}_{A C} + β {h}_{BA} {\hat{x}}_{CA} + {n}_{A} - β {h}_{BA} {x}_{A C} \\ = β {h}_{BA} {\hat{x}}_{CA} + {n}_{A} + β {h}_{BA} ( {\hat{x}}_{A C} - {x}_{A C} )\end{matrix} \qquad ( 3.8 )$$

Likewise, x_{AC} can be estimated as

\tilde{x}_{AC}=β⁻¹h_{BC}⁻¹r_{C} (3.9)

where

r_{C}=βh_{BC}\hat{x}_{AC}+n_{C}+βh_{BC}(\hat{x}_{CA}−x_{CA}) (3.10)

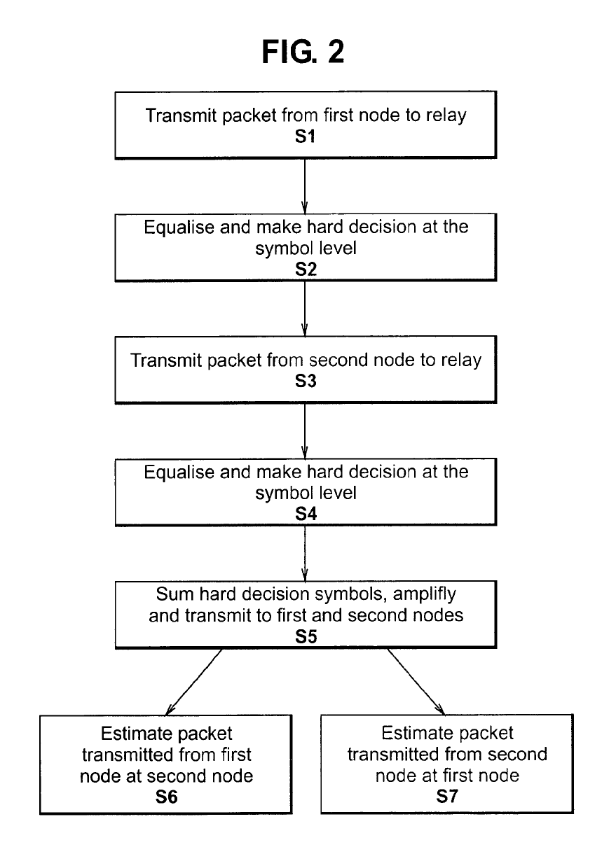

Reference is now made to FIG. 2 which illustrates a flow diagram of the method described, in relation to FIG. 1d. Firstly, as indicated by reference S1, a packet is transmitted from the first node to the relay.

As indicated by S2, at the relay, the received packet from the first node is equalised and a hard decision is made at the symbol level.

In the next stage, S3, a packet is transmitted from the second node to the relay.

As a fourth stage, S4, the relay equalises and makes a hard decision at the symbol level in respect of the packet received from the second node. It should be appreciated that stages S2 and S4 may take place more or less at the same time. Stage S2 can be carried out after stage S3 or before.

In stage S5, the relay sums the hard decision symbols in respect of the packet received from the first node and the second node, amplifies the result and transmits the resulting symbols to both the first node and the second node.

Stages S6 and S7 may take place more or less at the same time or one after the other. Stage S6 comprises the second node estimating the packet transmitted from the first node whilst stage S7 comprises the first node estimating the packet transmitted from the second node.

Reference is now made to FIG. 1e which shows a second embodiment of the invention. This embodiment is an amplify-and-forward embodiment which uses pre-equalisation to avoid the need for signalling overhead as shown in the example of FIG. 1c. During the first time slot, the first node and the second node transmit h_{AB}⁻¹x_{AC} and h_{CB}⁻¹x_{CA} respectively to relay node B simultaneously or at more or less the same time with pre-equalization. In other words, the first node and second node apply pre-equalisation to the packet before the packet is transmitted. The pre-equalisation is to compensate for the effects of the channel. The received data at the relay can be written as

$$\begin{matrix}{y}_{B} = {h}_{AB} {h}_{AB}^{- 1} {x}_{A C} + {h}_{CB} {h}_{CB}^{- 1} {x}_{CA} + {n}_{B} \\ = {x}_{A C} + {x}_{CA} + {n}_{B}\end{matrix} \qquad ( 3.11 )$$

During the second time slot, the relay amplifies y_{B} with a normalizing factor β and broadcasts it to both the first node and the second node, where the average transmitted signal energy over one symbol period at the relay is the same as the first node as

$$\begin{matrix}β = \sqrt{\frac{1}{E \{ {\vert {x}_{A C} \vert}^{2} \} + E \{ {\vert {x}_{CA} \vert}^{2} \} + {σ}_{B}^{2}}} \\ = \sqrt{\frac{1}{2 + {σ}_{B}^{2}}}\end{matrix} \qquad ( 3.12 )$$

The received signal at the first node is

$$\begin{matrix}{y}_{A} = β {h}_{BA} {y}_{B} + {n}_{A} \\ = β {h}_{BA} {x}_{A C} + β {h}_{BA} {x}_{CA} + β {h}_{BA} {n}_{B} + {n}_{A}\end{matrix} \qquad ( 3.13 )$$

With the knowledge of h_{BA}, x_{AC} and β, x_{CA} can be estimated as

\hat{x}_{CA}=β⁻¹h_{BA}⁻¹r_{A} (3.14)

where

$$\begin{matrix}{r}_{A} = β {h}_{BA} {x}_{A C} + β {h}_{BA} {x}_{CA} + β {h}_{BA} {n}_{B} + {n}_{A} - β {h}_{BA} {x}_{A C} \\ = β {h}_{BA} {x}_{CA} + β {h}_{BA} {n}_{B} + {n}_{A}\end{matrix} \qquad ( 3.15 )$$

Likewise, x_{AC} can be estimated as

\hat{x}_{AC}=β⁻¹h_{BC}⁻¹r_{C} (3.16)

where

r_{C}=βh_{BC}x_{A}+βh_{BC}n_{B}+n_{C} (3.17)

Thus, in this embodiment, it is possible to estimate the signals from a source node at a destination node without requiring information as to the CSI between the source node and the relay node.

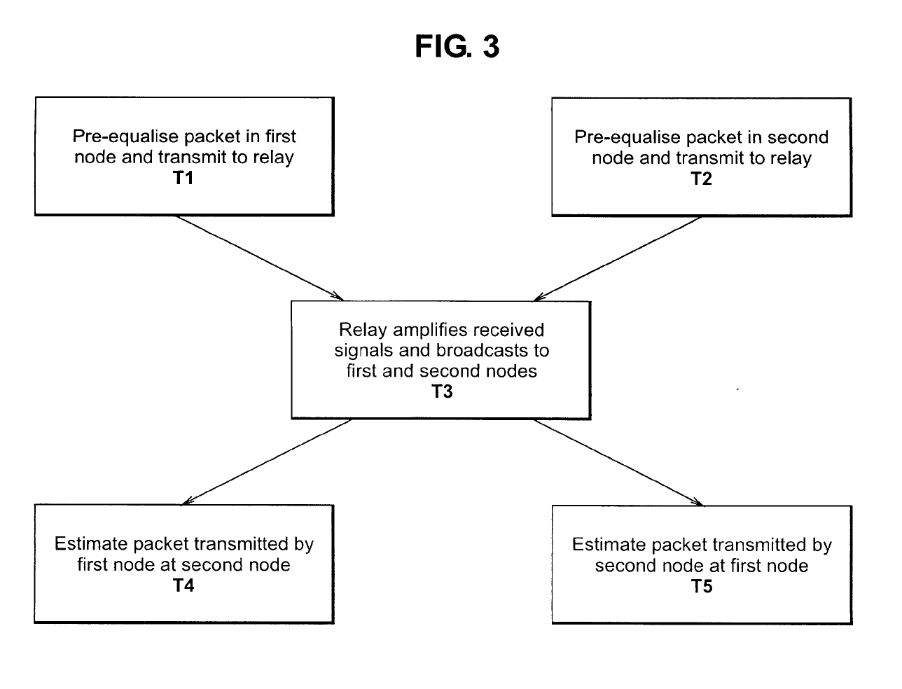

Reference is made to FIG. 3 which shows a flow diagram illustrating the method of the second embodiment of the invention.

In stage T1, a packet is pre-equalised in the first node and transmitted by the first node to the relay. In the second stage T2, a packet a pre-equalised in the second node and is transmitted by the second node to the relay. It should be noted that stages T1 and T2 may take place at the same time, or one stage may take place before or after the other.

In stage T3, the relay amplifies the received signal from the first and second nodes and broadcasts the combined signal to the first and second nodes. In one alternative embodiment, the relay may transmit to the first and second nodes at different respective times.

In stage T4, the second node estimates the packet transmitted by the first node from the broadcast received from the relay. Likewise, in stage T5, the first node estimates the packet transmitted by the second node and received from the relay. It should be appreciated that stages T4 and T5 can take place more or less at the same time or one after the other.

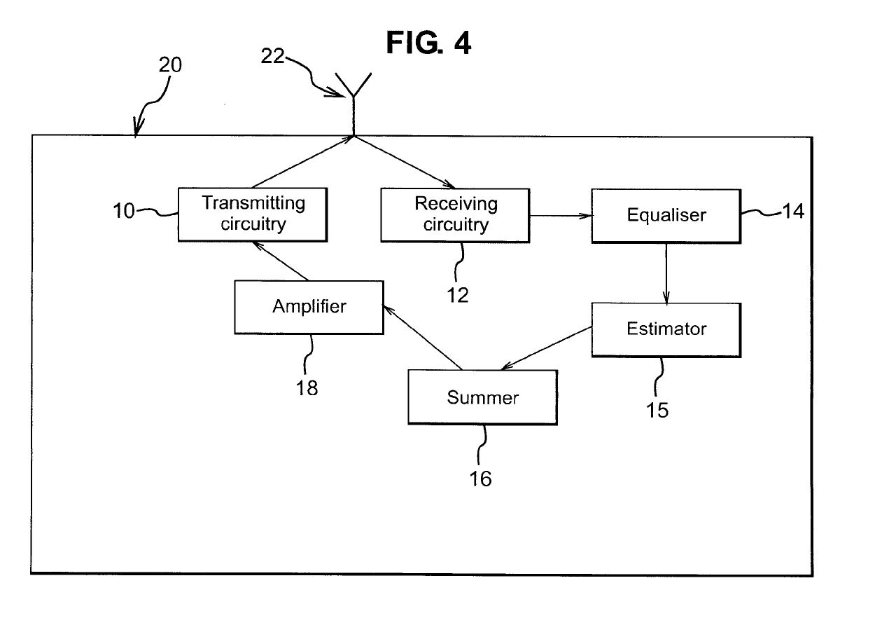

FIG. 4 shows a first relay embodying the present invention, and in particular, a relay suitable for implementing the embodiment described in relation to FIG. 1d. The relay 20 comprises an antenna 22. The antenna 22 is connected to transmitting circuitry 10 and receiving circuitry 12. Signals which are received by the antenna 22 are passed to the receiving circuitry 12. This receiving circuitry will convert the received signals to a baseband signal which is passed to an equaliser 14. The equaliser equalises the received signal and provides an output to the estimator 15 which makes hard decisions at the symbol level. The estimated symbols 15 are output to a summer 16. The summer 16 is arranged to sum the estimated symbols received from the first node with the estimated symbols received the second node. The summed symbols are output to the amplifier 18 which amplifies the symbols. The amplified symbols are output to the transmitting circuitry 10 which converts the signals which are at the baseband to the required radio frequency and passes the radio frequency signals to the antenna 22 for transmission.

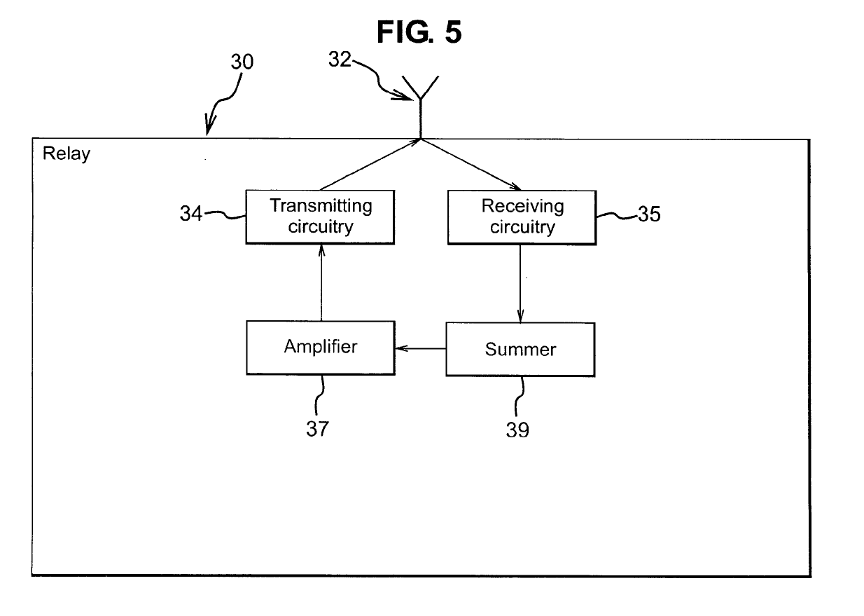

FIG. 5 shows a second relay embodying the present invention and in particular a relay suitable for implementing the embodiment described in relation to FIG. 1e. The relay comprises an antenna 32 connected to transmitting circuitry 34 and receiving circuitry 35. The relay receives signals from the first and second nodes via the receiving circuitry 35 which converts the received signals to the base band. A summer 39 sums the base band signals received from the two nodes and passes the summed signal to an amplifier 37 which amplifies the combined signal. The combined signal is then passed to the transmitting circuitry 34 which converts the signal to the radio frequency for transmission by the antenna 32.

It should be appreciated that in alternative embodiments of the invention, the relay node does not need to reduce the signal to the baseband but instead processes the signal at the radio frequency level.

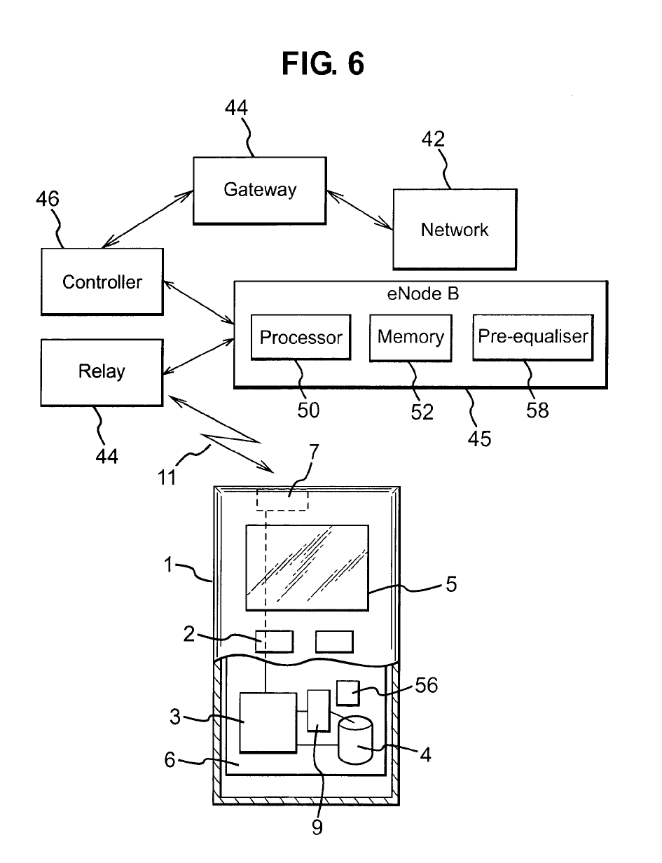

One example of a network within which embodiments of the present invention may be incorporated will now be described with reference to FIG. 6.

A communication device, for example a user device can be used for accessing various services and/or applications provided by a communications system. In the context of the examples previously given, the communication device would be one of the first and second nodes. In wireless or mobile systems, the access is provided via an access interface between a user device and an appropriate wireless access system. The user device can typically access wireless communications system via at least one base station or similar wireless transmitter and/or receiving node via a wireless connection 11. In the context of embodiments of the invention, the wireless communication 11 will be with relay 44, embodying the present invention. A further wireless connection will be provided between the relay 44 and the base station 45. With reference to FIG. 1, the relay 44 corresponds to Node B. One of the base station and user equipment will be the first node whilst the other of the user equipment and the base station will be the second node.

Examples of access nodes include a base station of a cellular system and a base station of a wireless local area network.

The base station may be connected to other systems, for example a data network 42. A gateway function between a base node and other network may be provided by means of any appropriate gateway node 44, for example a packet data gateway and/or an access gateway.

A base station is typically controlled by at least one appropriate controller entity 46. The controller entity can be provided for managing the overall operation of the base station and communications via the base station. The controller entity is typically provided with memory capacity and at least one data processor. Functional entities may be provided in the controller by means of data processing capabilities thereof. The functional entity provided in the base station controller may provide function relating to radio resource control, access control, packet data context control and so forth.

Certain embodiments of the present invention can be used in the long term evolution (LTE) radio system. This system provides an evolved radio access system that is connected to a packet data system. Such an access system may be provided, for example, based on architecture that is known from the E-UTRA (evolved UMTS(Universal mobile telecommunications system) terrestrial radio access) and based on the use of E-UTRAN node Bs (ENBs).

It should be appreciated that the architecture shown in FIG. 6 is by way of example only and there are other networks with which embodiments of the present invention may be used.

Some embodiments of the present invention may be used with the proposed IMT IMT (International Mobile Telecommunications)-Advanced system.

Alternatively, embodiments of the present invention may be used with the wireless local area network type arrangement.

The user device 1 can be used for various tasks such as making and receiving telephone calls, the receiving and sending data from and to a data network and for experiencing, for example, multimedia or other content. For example, a user device may access data application provided by a data network.

An appropriate user device may be provided by any device capable of sending and receiving radio signals. Non-limiting examples include a mobile station (MS), a portable computer provided with a wireless interface card or other wireless interface facility, a personal data assistant (PDA) provided with wireless communication capabilities, or any combination of these or the like.

The mobile device may communicate via an appropriate radio interface arrangement of the mobile device. The interface arrangement may be provided for example by means of a radio part 7 and an associated antenna arrangement.

The mobile device is typically provided with at least one data processing entity 3 and at least one memory 4 for use in tasks such as it is designed to perform. The data processing and storage entities can be provided on an appropriate circuit board, on an integrated circuit or in chipsets. This is denoted by reference 6.

Also shown is a modulated component 9 connected to the other elements. It should be noted that the modulated function may be arranged to be provided by the data processing entity 3 instead of via a separate component.

The user can control operation of the mobile device by means of a suitable user interface such as a keypad 2, voice commands, touch-sensitive screen or pad, combination thereof or the like. A display 5, a speaker and a microphone are also typically provided. Furthermore, a mobile device may comprise appropriate connectors (either wired or wireless) to either devices and/or for connecting external accessories, for example hands-free equipment thereto.

It should be appreciated that in the context of the first embodiment the processor 3 of the user device will carry out the calculation to estimate X_{AC} or X_{CA}, depending on which of the nodes the user equipment is regarding as being.

The memory 4 will be arranged to store the values of H_{BA}, X_{AC} and β in the case that X_{CA} is being calculated or H_{BC}, X_{AC} and B in the case that X_{AC} is being calculated. It should be appreciated that in some embodiments of the present invention, knowledge of the channel characteristic will be calculated by the user device.

It should be appreciated that the base station will similarly have data processing capacity 50 and memory 52 such that it can also make an estimation as to the packet which is being transmitted to it from the user equipment.

In order to perform the second embodiment, the user equipment and also the base station will be provided a pre-equaliser 56 and 58 respectively which will pre-equalise the packet before transmitting it to the relay.

It should be appreciated that embodiments of the present invention can be used in any context where a first node and a second node communicate via a relay.

It should be noted that although certain embodiments are being described by way of example with reference to certain exemplifying architectures, embodiments may be apply to any other suitable form of communications system and may at least be partially implemented by a computer program. For example, any one or more of the equations which are required to be performed may be carried by a computer program by means of a suitable processor or the like. It is also noted here whilst the above-described exemplifying embodiments of the invention have been described, there are several variations and modifications which may be made without the parting from the scope of the present invention.

1. A relay method comprising:
receiving data from a first node and a second node;
estimating symbols in the data received from said first node and said second node;
transmitting the estimated data from the first node to the second node and the estimated data from the second node to the first node.

2. A relay method as claimed in claim 1, comprising receiving the data from the first node and the second node at substantially the same time.

3-29. (canceled)

30. A relay method as claimed in claim 1, comprising summing the estimated symbols for the data from the first node and the estimated symbols for the data from the second node.

31. A relay method as claimed in claim 30, wherein transmitting the estimated data to said first and second nodes comprises transmitting the summed estimated symbols.

32. A relay method as claimed in claim 31, comprising transmitting the estimated data to the first and second nodes at the same time.

33. A relay method as claimed in claim 32, comprising equalising said data from the first node and from the second node.

34. A relay method as claimed in claim 33, comprising amplifying said estimated data prior to transmitting said estimated data.

35. A relay comprising;
a receiver configured to receive data from a first node and a second node;
an estimator configured to estimate symbols in the data received from said first node and said second node; and
a transmitter configured to transmit combined data from the first node to the second node and the estimated data from the second node to the first node.

36. A relay as claimed in claim 35, comprising a summer configured to sum the estimated symbols for the data from the first node and the estimated symbols for the data from the second node.

37. A relay as claimed in claim 35, comprising an equaliser configured to equalise said data from the first node and from the second node.

38. A relay as claimed in claim 35, comprising an amplifier for amplifying said estimated data prior to transmitting said estimated data.

39. A relay method comprising:
pre-equalising a first signal to be transmitted at a first node;
transmitting from said first node said pre-equalised first signal to a relay;
pre-equalising a second signal to be transmitted at a second node;
transmitting from said second node said pre-equalised second signal to said relay;
receiving said signals transmitted by said first and second nodes and said relay; and
transmitting said received signals to said first and second nodes from said relay.

40. A relay method as claimed in claim 39, comprising combining said signals transmitted by said first and second nodes at said relay

41. A relay method as claimed in claim 39, comprising transmitting said first pre-equalised and said second pre-equalised signals at substantially the same time.

42. A relay method as claimed in claim 39, comprising transmitting said received signals to said second and first nodes at substantially the same time.

43. A relay method as claimed in claim 39, comprising receiving said first and second signals at said relay, wherein said pre-equalising compensating for channel effects between said first node and said relay, and between said second node and said relay respectively.

44. A relay method as claimed in claim 39, comprising amplifying at the relay, the received signals prior to transmitting by said relay.

45. A relay method as claimed in claim 39, comprising receiving at one or both of said first and second nodes said signals transmitted by said relay.

46. A relay method as claimed in claim 45, comprising processing at said first node said signals received from said relay to remove a component based on said first signal therefrom to estimate a signal transmitted from said second node to said first node via said relay.

47. A relay method as claimed in claim 45, comprising processing at said second node said signals received from said relay to remove a component based on said second signal therefrom to estimate a signal transmitted from said first node to said second node via said relay.
